(19) United States
(12) Patent Application Publication
(10) Pub. No.: US 2010/0278700 A1
(43) Pub. Date: Nov. 4, 2010

(54) STEAM REFORMER WITH PASSIVE HEAT FLUX CONTROL ELEMENTS

(76) Inventors: Lawrence CLAWSON, Dover, MA (US); Michael Leshchiner, Needham, MA (US); James C. Cross, III, Carlisle, MA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/750,072

(22) Filed: Mar. 30, 2010

Related U.S. Application Data
(60) Provisional application No. 61/164,711, filed on Mar. 30, 2009.

(51) Int. Cl. B01J 19/00

(52) U.S. Cl. 422/198

(57) ABSTRACT

Provided is a steam reformer, comprising a burner zone comprising a hot combustion exhaust gas and a heat flux control element, a reforming zone comprising a gas flow of steam reforming reactants and a reformate gas, and a heat exchange boundary segregating the burner zone and the reforming zone.

Steam reforming is a method for producing hydrogen from hydrocarbons, such as methane. The basic chemistry of steam reforming is the temperature-driven reaction of a hydrocarbon with water to produce a “synthesis gas” (a mixture of primarily hydrogen, water, carbon monoxide, and carbon dioxide), sometimes more generally referred to as a “reformate.” This reaction is generally accelerated using a catalyst, e.g., nickel, precious metals, or other materials. The catalyst sometimes contains special components, i.e., promoters, to enhance its catalytic activity and longevity.

A “steam reformer” or “burner/reformer assembly” consists of two distinct flow regions: (1) one region, often called the “burner zone,” contains hot gases that provide the source of thermal energy, generally produced by the combustion of fuel and oxygen: and (2) the other region, often called the “reforming zone,” is where the endothermic steam reforming reaction between fuel and steam takes place. These two regions are physically separated by a heat exchange boundary, e.g., a metal surface, across which thermal energy is transferred from the burner zone to the reforming zone.

One of the challenges in steam reforming is that a large amount of energy must be transferred from the burner zone to the reforming zone through the heat exchange boundary to sustain the reaction at a proper reaction temperature. The reaction temperature affects hydrocarbon conversion equilibrium and reaction kinetics. Higher reaction temperatures in the reforming zone correspond to higher reaction rates, higher hydrocarbon conversions, and a lower amount of residual hydrocarbons in reformate. However, high reaction temperatures may cause severe thermal stress, corrosion, creep, and fatigue in the metal components in the steam reformer (including specifically the heat exchange boundary), as well as catalyst degradation. Conversely, low reaction temperatures in the reforming zone may reduce metal stress, corrosion, creep and fatigue, but may lead to lower hydrocarbon conversions and a higher amount of unreacted hydrocarbons in the reformate. The more hydrocarbons left unreacted in the reformate, the less efficient the steam reformer system becomes—leading to a higher cost of hydrogen and a higher level of carbon dioxide (greenhouse gas) emissions per unit of hydrogen produced.

Large scale industrial steam reformers often have a multiplicity of reformer tubes as the heat exchange boundary, surrounded by “impingement” style burner modules. In an impingement style burner, a fuel-air mixture is fired in the space around the tubes, either directly toward the reformer tubes, along them, or some combination thereof. Heat flux into the heat exchange boundary from the burner zone occurs via both radiative and convective heat transfer. The reforming zone of such steam reformers operates at a high temperature (e.g., >850° C.) and at an elevated pressure as high as about 30 bars, running continuously with few startup-shutdown cycles and limited thermal stress and fatigue. To control the temperature profile along the length of the reactor tubes, large industrial reformers sometimes use staged combustion, placing multiple burner heads along the reformer tubes to avoid hot spots from occurring when a single burner provides all the thermal energy.

Deploying small scale steam reformers near the point of consumption avoids the large capital investment of constructing centralized reforming plants. On the other hand, for many applications, e.g., a hydrogen fueling station serving a small fleet of fuel cell vehicles, the demand of hydrogen may be intermittent. Consequently, the steam reformers must be able to sustain frequent startup-shutdown cycles, which often cause temperature excursions that shortens the reformer life. The small scale steam reformers, however, can generally not afford the expense and complexity of staged combustion, and often use a single stage in situ combustion within or near where the reforming reaction occurs, e.g., a reformer tube. However, this arrangement can result in localized high temperatures on the reformer tubes. Additionally, heat flux, especially the part from radiative heat transfer (the other part being convective heat transfer), is diminished along the direction of the combustion exhaust, whose temperature decreases, i.e., heat transfer theory provides that the radiative component of heat flux scales with temperature to the fourth power.

### BRIEF DESCRIPTION OF THE DRAWINGS

FIG. 1 shows a schematic of a reformer-burner configuration wherein the burner is located upstream of the steam reformer.

FIG. 2a show a steam reformer of the invention comprising a shell, reformer tubes, connecting tubes, and inserts.

FIG. 2B provides a detailed view of the connecting tubes of FIG. 2a.

FIG. 3 shows the temperature profile of the exhaust, wall, and reformate along the length of reformer tubes where an insert is present (new) and where an insert is not present (conventional).

FIG. 4a shows the predicted cross-sectional temperature distribution of a reformer tube at a high temperature with an insert.

FIG. 4b shows the predicted cross-sectional temperature distribution of a reformer tube at a high temperature without an insert.

FIG. 5 shows an embodiment of the invention comprising end plates, gaskets, partition walls and inserts wherein the steam reformer channel and the exhaust channel are stacked adjacent to each other.

FIG. 6a shows a cross-sectional view of a burner-reformer assembly of the invention wherein the exhaust gas glows through one or more conduits, the conduits being surrounded by a reforming region.

FIG. 6b shows a conduit useful in the invention having a single, a shelf-type support and a ring positioned for locating said insert.

FIG. 6c shows a conduit useful in the invention having a varying shape along the flow direction

FIG. 6d shows a conduit useful in the invention having an insert assembly consisting of stacked insert elements.

FIG. 6e shows a shelf containing holes to allow flow-through, useful for locating an insert.

FIG. 6f shows spokes useful for locating an insert.

FIG. 7a shows a schematic of a steam reformer of the invention comprising an integrated, repeating array of exhaust gas passage (X) and reforming passage (R) conduits.

FIG. 7b shows a more detailed view of the array of FIG. 7a.

FIG. 7c shows a perspective view of a cross-section of an exhaust conduit having an insert located therein.

FIG. 8a shows an insert having a variable pitch, helical turbulator type fin.

FIG. 8b shows an insert having a block-type fin.

FIG. 8c shows a cross-sectional view of an insert having a block-type fin, the cross-section being of a portion of the insert located closer to the exhaust gas inlet.

FIG. 8d shows a cross-sectional view of an insert having a block-type fin, the cross-section being of a portion of the insert located closer to the exhaust gas outlet.

FIG. 9a shows reformer tubes and an insert that is unitized structure which may replace a multiplicity of individual inserts, and.

FIG. 9b shows the insert depicted in FIG. 9a in the absence of the reformer tubes.

FIG. 9c shows an insert having a unitized structure that conforms to the geometry of the steam reformer heat exchange boundary.

FIG. 10 shows various modes of heat transfer of certain embodiments of the steam reformer of the invention.

FIG. 11a shows portions of a number of inserts having various surface textures, including roughened (1), dimpled (2), corrugated straight (3), corrugated helical (4), block notched (5), or sawtooth notched (6).

FIG. 11b shows cross-sectional views of portions of a number of inserts, each having different shape transitions, including straight taper (bevel or chamber) (1), right angle (2), convex (3), concave (4), and hybrid (5).

FIG. 12a shows an insert having a uniform surface material.

FIG. 12b shows an insert having a variegated surface material.

FIG. 12c shows a composite insert, having separators.

FIGS. 13a and 13b show inserts having a conductive core.

FIG. 13c shows an insert having a core comprising an array of conductive channels.

FIG. 13d shows an insert having a conductive core adapted to provide a means for attaching the insert to another component.

The present application discloses a steam reformer in which the burner zone contains passive heat flux control elements (either geometric features or distinct functional inserts) to modulate convective and/or radiative heat flux to the heat exchange boundary.

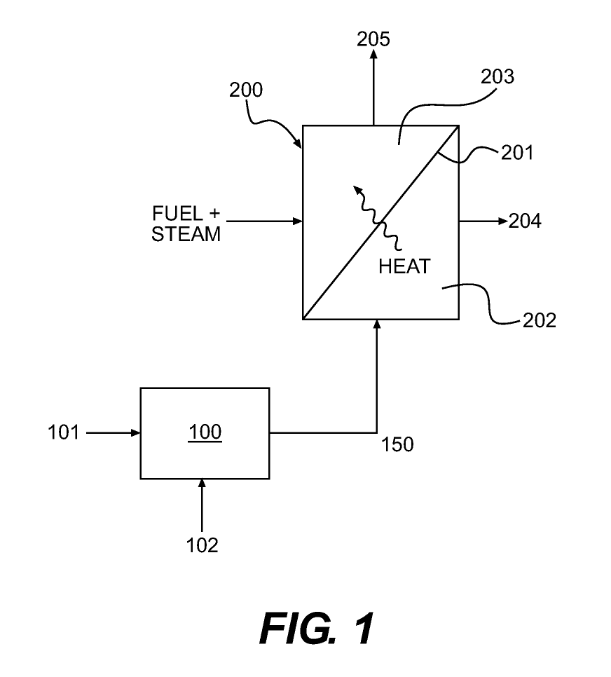

FIG. 1 is a schematic of an embodiment of a burner-reformer process configuration of the current disclosure. This system comprises two main components: (1) a burner (100), either an open flame burner with a defined flame front, or a thermal reactor with a self-sustaining extended combustion zone; and (2) a steam reformer (200) heated by the high temperature exhaust gas (150) from the burner. Fuel (101) and air (102) are added to the burner/reactor to produce the exhaust gas (150).

One feature of the steam reformer in the system in FIG. 1 is the heat exchange boundary (201), i.e., the material boundary segregating the two flow regions: (1) the higher temperature burner zone (202) through which the higher combustion products (150) are flowing; and (2) the lower temperature reforming zone (203) in which reforming reactants and products are flowing. A variety of geometries of the heat exchange boundary and the flow regions can be conceived. It is understood that the heat exchange boundary need not be a single, continuous surface—it may be a collective boundary comprising a number of individual surfaces, e.g., a plurality of tubes.

In the apparatus of FIG. 1, the combustion reaction occurs upstream of the steam reformer so that the flame, which has a high temperature front, does not contact the heat exchange boundary. Instead, the hot exhaust gas downstream of the flame, which has a substantially uniform temperature, enters the steam reformer and contacts the heat exchange boundary. In the process, the hot exhaust gas provides heat to the catalysts and the reformer reactant mixture via heat transfer through the heat exchange boundary without overheating it. The steam reformer can also contain at least one exhaust vent (204). A reformate (205), i.e., a synthetic gas, is collected from the steam reformer.

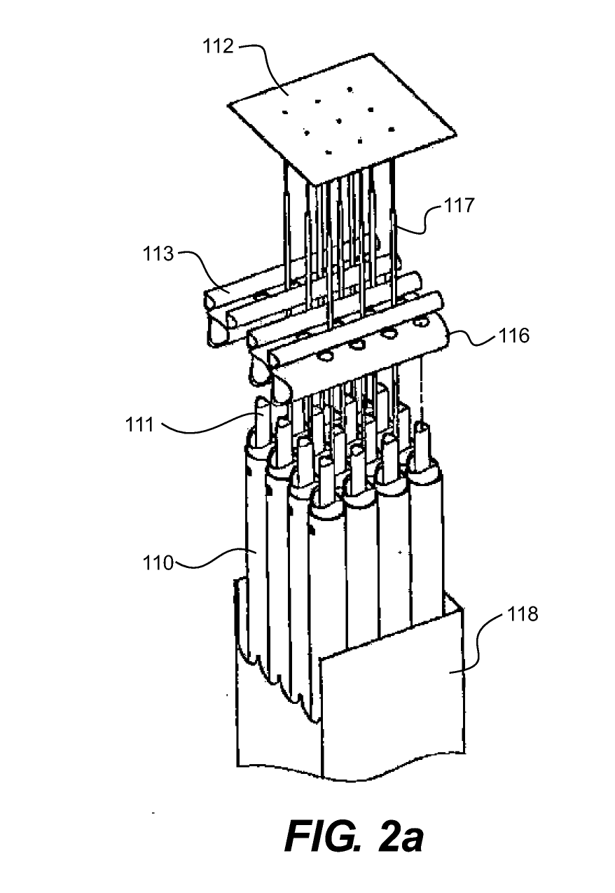

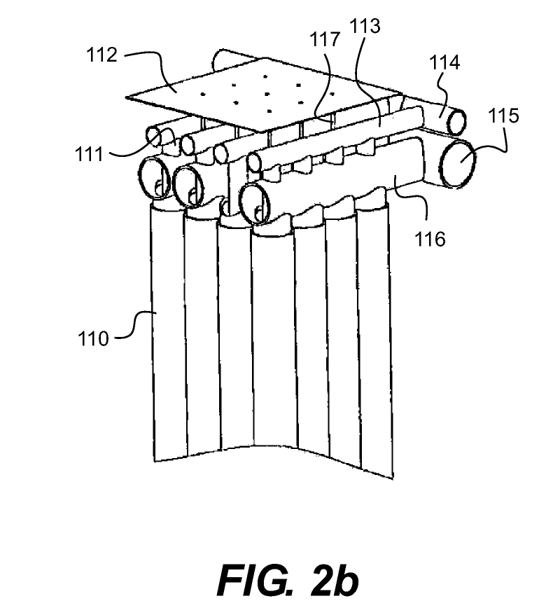

One embodiment of a steam reformer is shown in FIGS. 2a and 2b. The steam reformer comprises a shell (118) and a bundle of reformer tubes inside the shell. The tube can be in a circular, rectangular, oblong, or other geometric shapes. Each reformer tube has an inner tube (111) and an outer tube (110) arranged concentrically. Both the inner tube (111) and the outer tube (110) have a first and a second end. The first ends of a row of inner tubes (111) is connected to a connection tube (113), while the first end of a row of outer (110) tubes are connected to a connection tube (116). The second end of the outer tube (110) (not shown) is sealed, for example, with a metal plate or a cap. The second end of the inner (111) tube (not shown) opens into the outer tube (110) toward its sealed second end.

According to this embodiment, the connection tube (116) has one array of large holes and one array of smaller holes in its wall. The outer tubes (110) are connected to the connection tube (116) at the larger holes. The inner tubes (111), on the other hand, can pass through both the large and small holes and are connected to the holes in the wall of the connection tube (113).

As depicted in FIG. 2b, the connection tubes (116) are connected to a tube (115), while the connection tubes (113) are connected to a tube (114). The connections between the tubes can be formed by any known means to form a permanent, gas tight connection between the tubes. For metal tubes, such a connection can be formed, for example, by welding, brazing, etc. In this configuration, the gap between the inner and the outer tube is filled with steam reforming catalysts, while the inner tube is left empty.

Inserts (117), such as rods, hang from a plate (112) and are placed in the spaces between the reformer tubes where the exhaust gas is flowing, partially blocking the flow passage. The size and shape of the inserts may vary along its length to change the geometry (e.g. cross-sectional flow area) of the flow passage, as well as the heat exchange boundary exposed to radiative heat transfer.

In one operation mode, the tube (114) serves as a reactant inlet and the tube (115) serves as a reformate outlet. Therefore, the reactants flow through tube (114) and distribute among connection tubes (113), which in turn distributes the reactant gas to the reformer tubes via the inner tubes (111). The reactant gas exits from the second end of the inner tube (111) into the outer tube (110), reacting in the presence of the steam reforming catalyst to form a reformate. The product gas then exits the outer tube (110) via the connections tubes (116) and the tube (115) in succession.

In another operation mode, the tube (114) serves as the reformate outlet and the tube (115) serves as the reactant gas inlet. Consequently, the gas first travels through the outer tube before entering the inner tube.

The hot exhaust gas flow outside of the reformer tubes. The direction of the gas flow can be from the first end of the outer tube to the second end of the outer tube, and vice versa, and any other direction in between. Consequently, the exhaust gas flow in the burner zone (202) and the gas flow in the reforming zone (203) along the heat exchange boundary (201), e.g., a outer tube wall, can be concurrent, or countercurrent, or at an angle of any value in between.

As the hot exhaust gas transfers energy to the reformer tubes, its temperature decreases. Consequently, the temperature of the exhaust gas near the inlet of the exhaust gas is higher than its temperature downstream. Likewise, the local temperature of the reformer tube where it is exposed to a hotter exhaust gas is higher than the local temperature where it is exposed to a lower temperature exhaust gas. To achieve a more uniform temperature profile along the length of the reformer tube (reducing thermal gradients and their associated mechanical stresses), it is desirable to have a higher heat transfer coefficient where the exhaust temperature is low, and vice versa.

One aspect of the steam reformer of the current disclosure is that the geometry of the exhaust gas passage is altered using inserts (117) to change the local gas flow characteristics and correspondingly the convective heat transfer coefficient through the heat exchange boundary (201), e.g., the wall of the outer reformer tubes.

Another aspect of the steam reformer of the current disclosure is that the insert (117) can be designed to achieve a desired radiative heat flux profile along its length. For example, (1) the materials of construction can be chosen (e.g. on the basis of thermal conductivity) to influence thermal gradients in the insert (which affects the surface temperature distribution and associated radiative emission); and/or (2) the shape and surface characteristics (e.g. roughness, texture, contour, or emissivity-enhancing or reducing coatings) of the insert can be altered to enhance or reduce the intensity and/or directionality of local radiative heat flux.

Heated by the hot exhaust gas from the burner zone (202) via both convective and radiative heat transfer, the insert (117) achieves a local temperature closer to the local gas temperature than the local temperature of the heat exchange boundary (201), which is cooled due to the reforming endotherm. The insert (117) provides a means for selectively augmenting the heat transfer from the burner zone gases in providing the local heat flux to the heat exchange boundary (201). Design features in the inserts that affects the radiative and the convective heat flux include: a) macroscopic shape, which affects the radiation from the insert (117) that the heat exchange boundary (201) is exposed to; b) texture of the insert surface, which alters the surface area and micro-level exposure to radiation; c) the properties of the material of construction, including thermal conductivity, emissivity, heat capacity, and/or thermal expansion; and d) coatings selectively applied to the surface of the insert to alter the radiative heat flux in select regions.

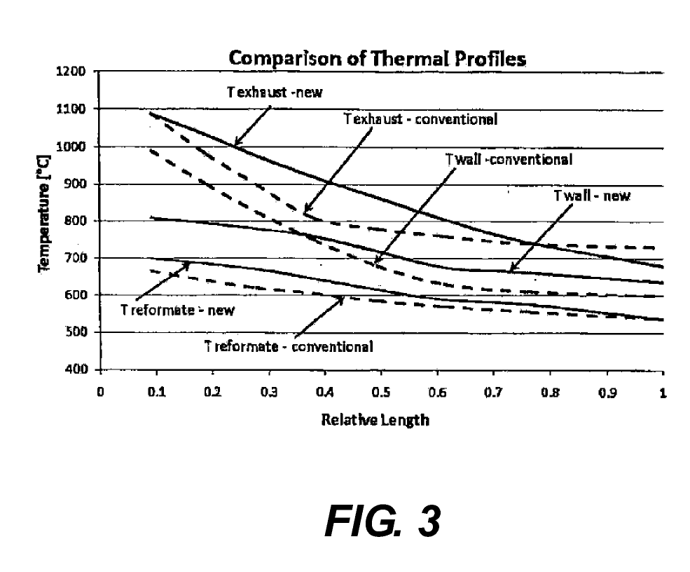

FIG. 3 compares the temperature profile along the length of a reformer tube in a steam reformer with and without the inserts (117). The temperature profile for the steam reformer having inserts (117) is more uniform, having a lower peak metal temperature, smaller temperature gradients along the tube, and higher reformate exit temperature than the one without an insert.

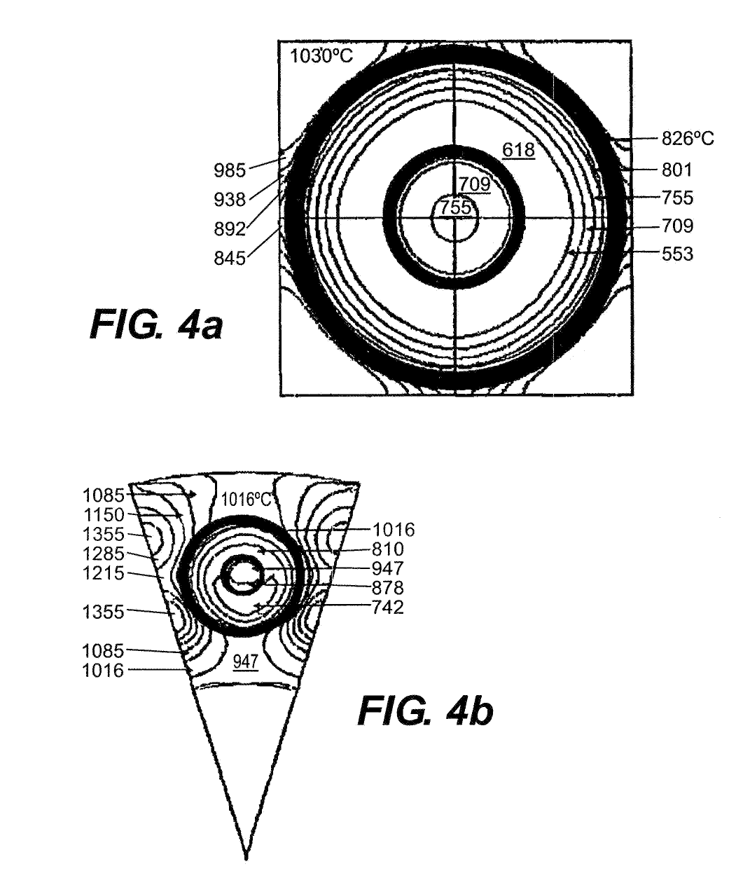

FIGS. 4a and 4b respectively show predicted cross-sectional temperature distributions at a high temperature location with and without inserts (117) installed. When no inserts are installed, the highest temperature of the outer tube (110) may reach 1016° C. In comparison, when inserts are present, the highest temperature of the outer tube (110) may only reach 826° C.

Other means to restrict the exhaust flow passage include installing elements (metallic or ceramic, including granules, meshes, reticulates/foams, wires or spokes) around the reformer tube bundles. Increasing the number of such elements will increase the mixing in the exhaust gas flow (leading to higher convective heat transfer) and increase the quantity of emissive material (leading to higher radiative heat transfer).

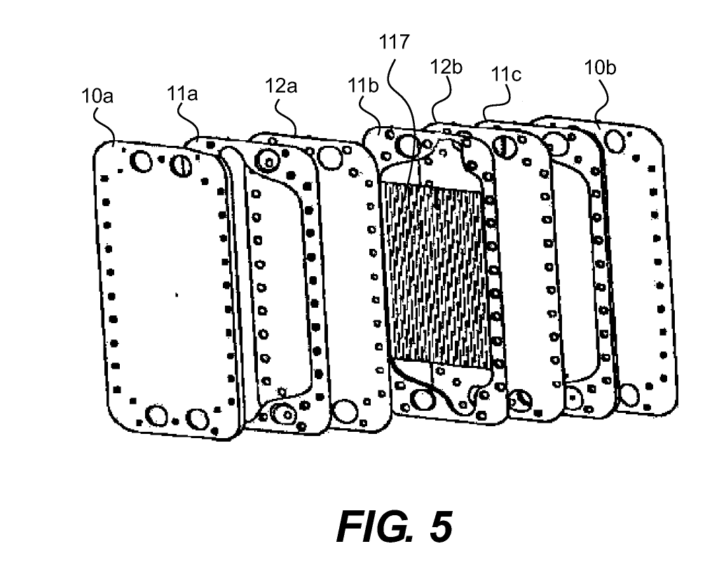

FIG. 5 shows another embodiment of the steam reformer. The reformer comprises end plates (10a, 10b), gaskets (11a, 11b, 11c), partition walls (12a, 12b), and inserts (117), such as a corrugated metal fin or sheet. When assembled, the end plates (10a), gaskets (11a), and partition walls (12a) form a steam reformer channel where steam reforming catalysts reside, while partition wall (12a), gasket (11b), and the partition wall (12b) form an exhaust gas channel in which the insert (117) resides. In this configuration, the steam reformer channel and the exhaust channel are stacked adjacent to each other and the number of the channels can be increased to scale up the reactor.

In this embodiment, the reactant mixture flows through the steam reformer channel and reacts in the presence of the steam reforming catalyst. The hot exhaust gas, on the other hand, passes through the adjacent exhaust gas channel and transfers heat to the steam reformer channel. The local heat transfer coefficient is increased by installing inserts of different geometry in the exhaust channel. Additionally, the insert serves to increase radiative heat flux to the heat exchange boundary.

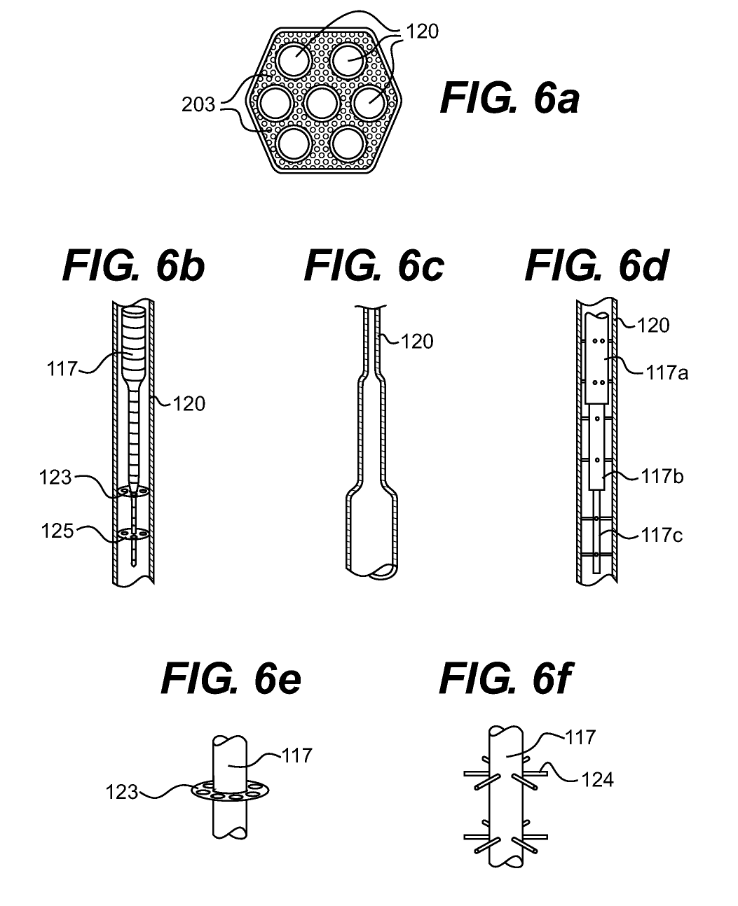

Another embodiment is shown in FIGS. 6a-6f. FIG. 6a provides a cross-sectional view of a burner exhaust/reformer assembly. In this embodiment, exhaust gases flow through a single conduit or a multiplicity of conduits (120), (e.g. tubes, which may be circular, elliptical, or other shapes, and whose cross-sectional form may vary along their length), while the reforming region (203) containing catalyst surrounds these conduits. Inserts are not depicted in FIG. 6a. Non-limiting examples of means to modulate heat transfer from the exhaust gases through the heat exchange boundary include:

(1) a single insert (117) in the conduit (120), wherein the cross-sectional form of the insert varies along its length; the insert can be either solid, hollow (e.g., capped upstream to avoid flow-through), or porous; the insert can be constructed of metal or ceramic; and shelf-type supports (123) and/or locating ring positioners (125) can be present (FIG. 6b);

(2) no insert, but rather the conduit (120) itself has a varying shape/form along the flow direction (FIG. 6c); and

(3) an “insert assembly” consisting of stacked insert elements (117a, b, and c), which can be either solid, hollow (e.g. open-top “cans”), or porous (FIG. 6d).

One of the features of the insert that increases heat flux to the heat exchange boundary in the direction of exhaust flow is its smaller profile (cross-sectional area) toward the exhaust flow inlet and its larger profile toward the exhaust outlet side. This approach increases both the convective heat transfer coefficient—and the area providing radiative heat transfer toward the exhaust flow outlet.

The insert (117) may be suspended via wires or rods, rested on or affixed to shelf type supports (123), which contain holes to allow flow-through (FIG. 6e). The insert (117) may also be held in position via spokes (124) (FIG. 6f), or other similar means. In addition to the function of positioning the inserts axially, shelves, spokes, or other ancillary components also position the inserts laterally with reference to the heat exchange boundary.

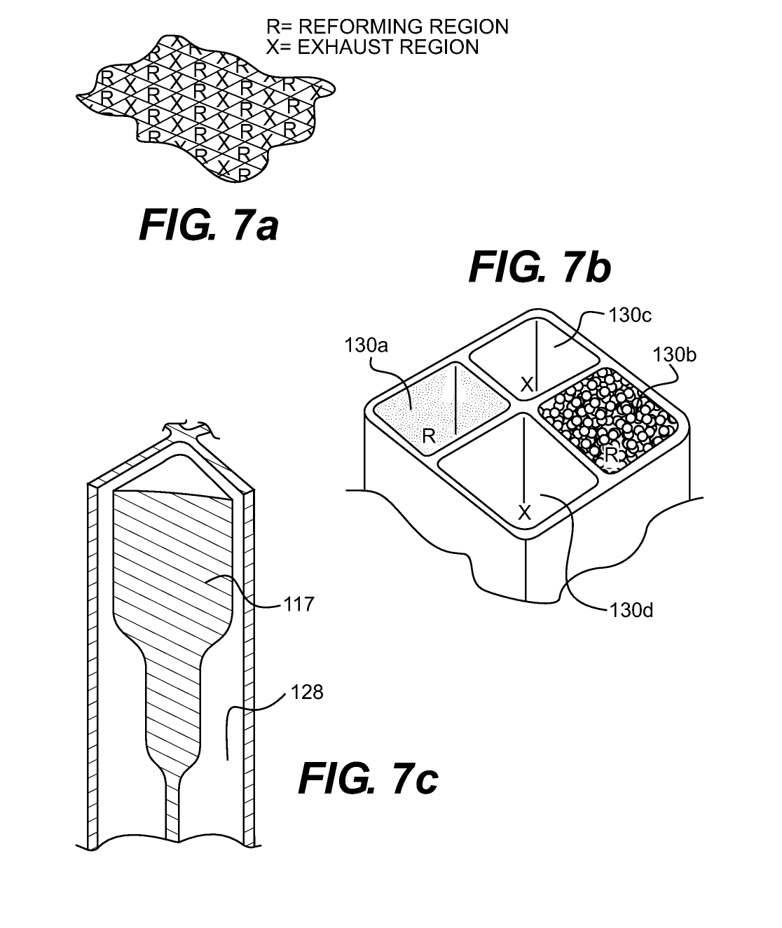

FIGS. 7a-7c shows another embodiment of steam reformer in this disclosure. In this embodiment, exhaust gas passages and reforming passages are placed in an integrated, repeating array of conduits, e.g., rectangular channels as in a honeycomb monolith. FIG. 7a shows one layout wherein the two distinct regions are placed according to a “checkerboard” type pattern, with R representing a reforming region and X representing an exhaust region. FIG. 7b shows more details of several conduits in such an array. In this embodiment, the reforming conduits (130a and b) can be, for example, washcoated with catalyst (130a), or filled, wholly or partially, with granular or pelletized catalyst media (130b). The exhaust conduits (130c and d) have inserts, which are not shown in FIG. 7b for simplicity. FIG. 7c shows a perspective view of a cross-section of an exhaust conduit (120) having an insert (117) located therein. The exhaust is able to flow through passage (128) in the conduit.

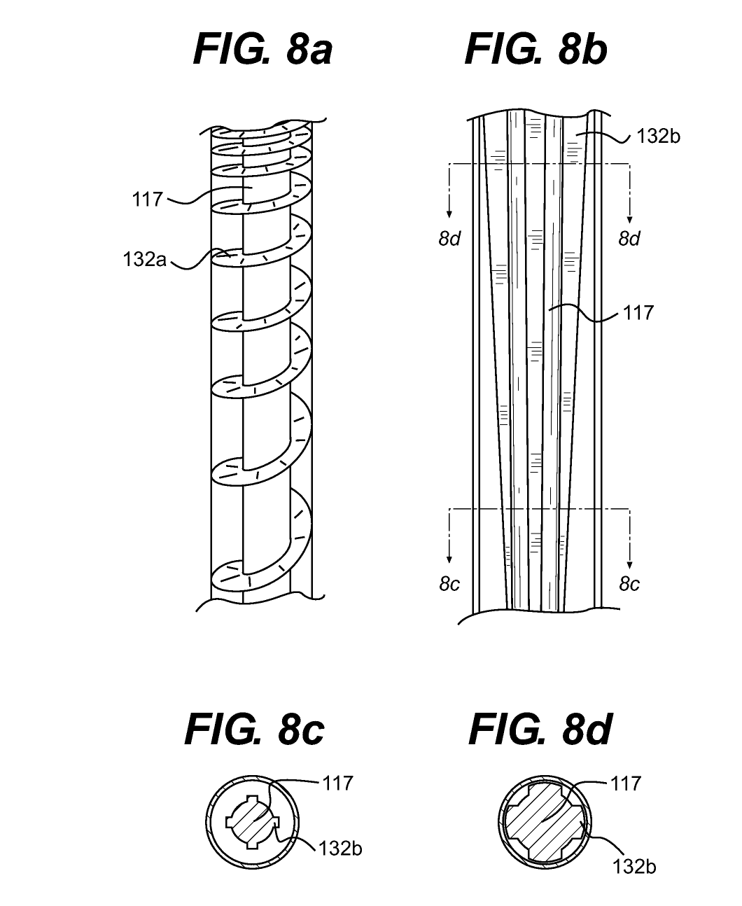

FIGS. 8a-8d show an embodiment wherein the insert has, or is surrounded by, fin-type elements. FIG. 8a depicts a variable pitch, helical turbulator-type fin (132a)—the helical cross-sectional flow area reduces in the direction of flow, thereby accelerating the fluid and increasing the convective heat transfer coefficient, and additionally increasing the density of radiative heat transfer area of the fin. In this embodiment, the fin (132a) may or may not be attached to the insert, and the fin (132a) may or may not be attached to the wall of the conduit. FIG. 8b depicts a block-type fin (132b)—the circumferential width and/or radial dimension of the fin increase in the flow direction. When the block-type fin is inserted into a flow conduit, the area of the flow passage decreases in the direction of flow, thus reducing the exhaust gas flow area and increasing its velocity, as well as increasing insert area per unit length in the flow direction, therefore enhancing convective and radiative heat transfer.

FIG. 8c shows a cross section of the block-type fin (132b) closer to the exhaust gas inlet (i.e., upstream), while FIG. 8d shows a cross section of the block-type fin (132b) closer to the exhaust gas outlet (i.e., downstream). In each of these figures, the core of the insert and the fins are depicted. Number, size, and shape of the fins can be tailored according to the steam reformer design specifications, e.g., pressure drop, height, operating pressure, etc.

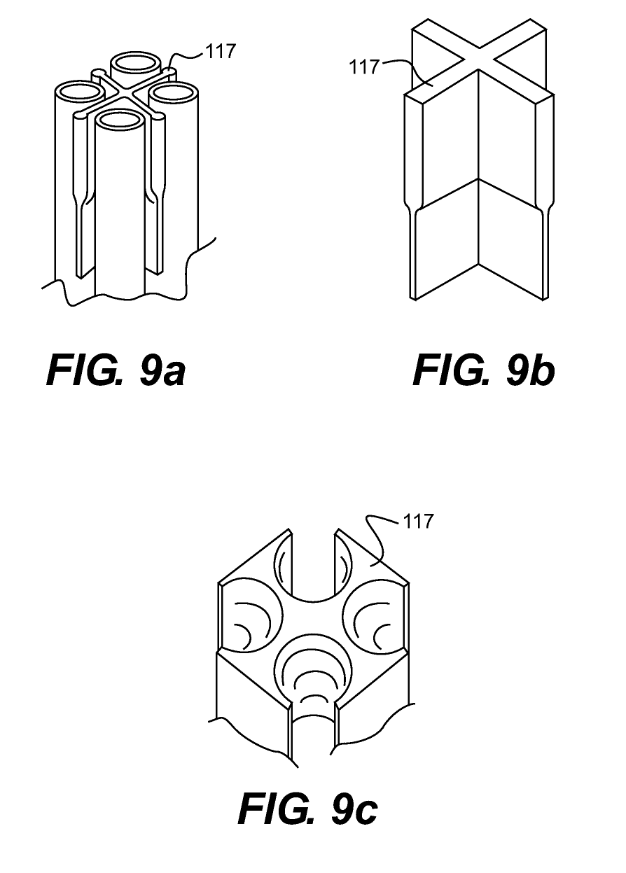

FIGS. 9a-9c show an embodiment in which the insert (117) has been made into a unitized structure which may replace a multiplicity of individual inserts. FIG. 9a shows the unitized insert located between a small two by two tube array. The detail of the insert (117), e.g., having a variable cross sectional flow area along length, is shown in FIG. 9b. FIG. 9c shows an insert (117) that conforms to the geometry of the steam reformer heat exchange boundary.

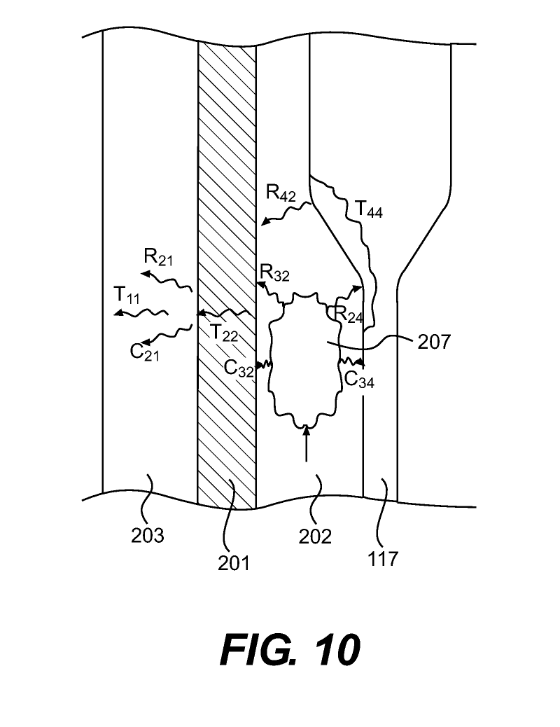

FIG. 10 depicts modes of heat transfer in certain embodiments of the steam reformer of this disclosure. In FIG. 10, C represents convective heat transfer, R depicts radiative heat transfer, and T represents conductive heat transfer. Compared to a steam reformer without inserts, the insert (117) increases convective heat transfer from the hot gases (207) in the burner zone (202) to the heat exchange boundary (201) (exemplary convective heat transfer is labeled “C32” in FIG. 10), and introduces radiative transfer from the burner zone (202) to the heat exchange boundary (201) (exemplary radiative transfer labeled “R42” in FIG. 10), both of which enhance the heat transfer characteristics of the steam reformer. The heat transfer then continues from the exchange boundary (201) to the reforming zone (203). There are multiple benefits to this approach including, for example, that the heat exchange boundary (201) can be used more effectively (e.g., more heat in per unit area requires less material and cost for a given production capacity), that the heat exchange boundary's life extended (e.g., due to reduction of peak temperatures and/or reduction of thermal gradients and corresponding stresses), or both.

Note that the insert (117) is more durable than the heat exchange boundary (201). An insert (117) is suspended, stacked, or otherwise structurally unconstrained. It is either hollow or solid and is not subject to a pressure differential. It interacts only with the burner exhaust, so has less extreme temperature gradients and correspondingly lower stresses. Consequently, the insert does not adversely impact the durability or life of the steam reformer. The direction and intensity of radiative heat transfer from the insert (117) to the heat exchange boundary (201) can be influenced by proper design of the insert's shape, size, surface texture, material of construction, and optionally coatings.

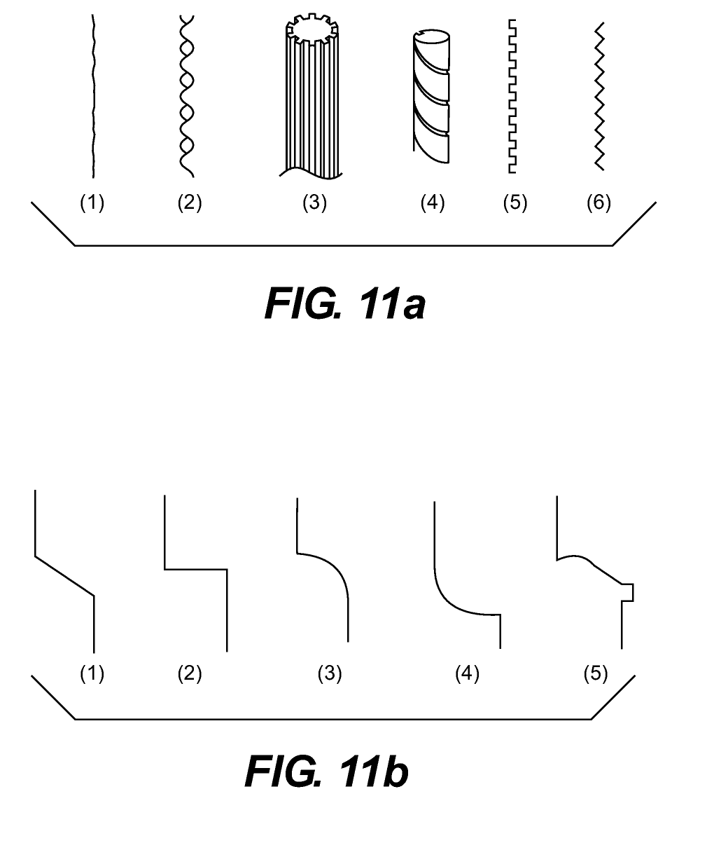

FIGS. 11a and 11b show insert surface textures and overall shapes/forms. The surface characteristics affect both the radiating area and directionality of the emitted radiant heat energy. The surface of the insert may be fully or partially tailored to achieve design objectives, viz. a specific heat flux profile on the heat exchange boundary—the surface may be roughened (1), dimpled (2), corrugated straight (3), corrugated helical (4), block notched (5), or sawtooth notched (6), as shown in FIG. 11a. Note that the heat exchange boundary may be similarly textured, with the additional benefit of positively affecting the local gas flow characteristics and enhancing convective heat transfer. At the macro level, a number of different shape transitions—where the insert cross-sectional profile changes—are available. FIG. 11b shows the depiction of shape transitions including, for example, a straight taper (bevel or chamfer) (1), right angle (2), convex (3), concave (4), and hybrid (5) forms. The type of shape transitions can be chosen according to radiative heat transfer characteristics and overall steam reformer design.

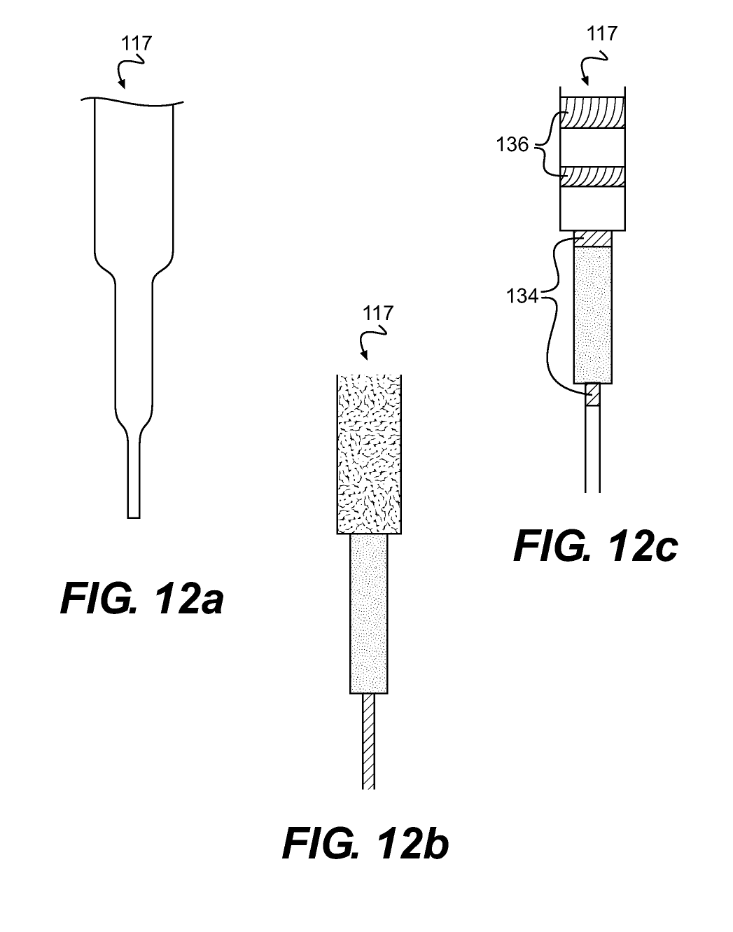

The temperature profile on the surface of and within the insert is affected by heat exchange between it, the exhaust gas, and the heat exchange boundary, as well as its thermal properties. For a given macroscopic insert shape/form, the temperature profile of the insert (117) can be influenced by the choice of material of construction (of the insert overall, or specific components of the insert), and/or application of surface coatings—as shown in FIGS. 12a-12c. For example, FIG. 12a depicts a uniform material, FIG. 12b depicts a variegated material, which can be chosen for different thermal conductivities, and FIG. 12c depicts a composite, with separators (134), such as thermal insulators, and/or surface treatments or coatings (136).

The insert body transmits heat from the higher temperature upstream region of the burner zone to the lower temperature downstream region, and the extent can be influenced by choice of materials—materials with higher thermal conductivity (such as tungsten, nickel, chromium, and iron) will facilitate higher heat transmission to a greater extent than those with lower conductivity (such as alumina, stainless steel, titania, and concrete). The insert (117) may be composed of variegated materials in different zones, as shown in FIG. 12b. Insulating materials (134) can be used to specifically segregate zones as shown in FIG. 12c. The radiative character of the insert surface (136) can also be modulated, either by surface treatments (such as etching, sandblasting, or electroplating) or coatings (chemical such as passivation layers or mechanical such as affixed straps/bands) as also shown in FIG. 12c. These features can be employed to achieve the emissivity value of the insert, which in turn impacts the local radiative heat flux.

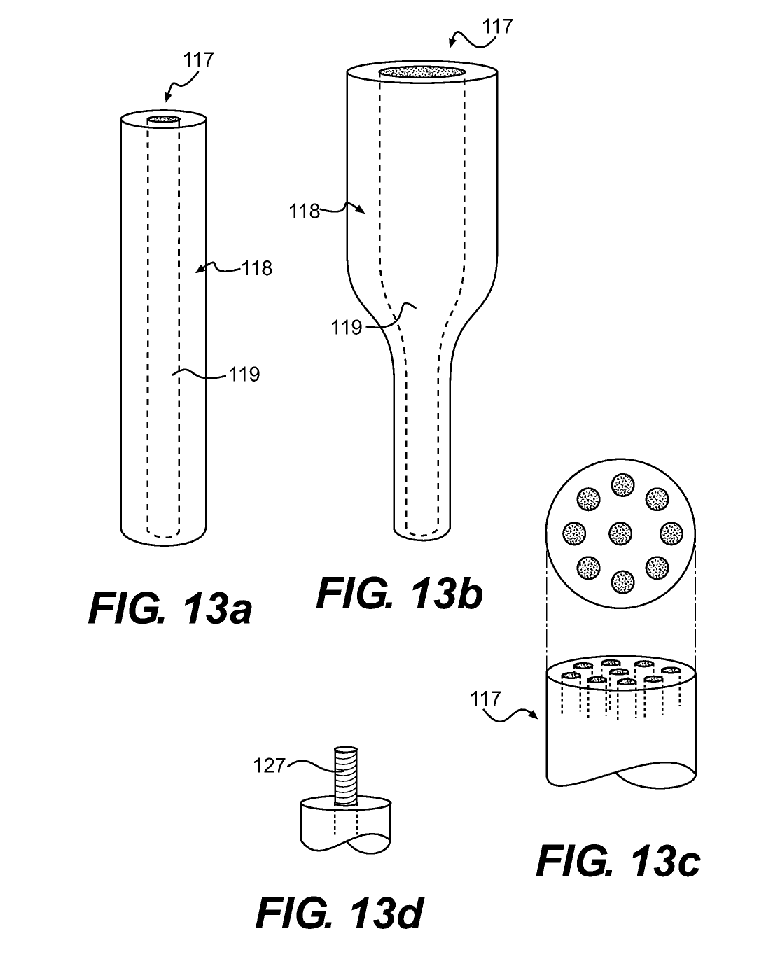

Further embodiments that promote even heat distribution via conduction through inserts are shown in FIGS. 13a-13d. In these embodiments, the insert (117) can comprise two or more components including, for example, a main structure (118) and one or more conductive core elements (119). The conductive core (119) can be either embedded or inserted into the main structure (118). It can be of the same or a different material than that of the main structure. FIG. 13a depicts a simple conductive core, FIG. 13b depicts a conforming core, and FIG. 13c depicts a conductive channel array in the insert. The core can be further adapted as the means for attachment to other components inside the burner zone, as indicated in FIG. 13d, with attachment 127 enabling the conductive element to act as a support.

We claim:

1. A steam reformer, comprising:
a burner zone comprising a hot combustion exhaust gas and a heat flux control element;
a reforming zone comprising a gas flow of steam reforming reactants and a reformate gas; and
a heat exchange boundary segregating the burner zone and the reforming zone.

2. A steam reformer of claim 1, wherein combustion occurs outside of the burner zone.

3. A steam reformer of claim 1, wherein the reforming zone further comprises one or more reformer tubes, at least one of which contains reforming catalyst.

4. A steam reformer of claim 1, wherein the flow of exhaust gas in the burner zone and the gas flow in the reforming zone adjacent to the heat exchange boundary are concurrent.

5. A steam reformer of claim 1, wherein the flow of exhaust gas in the burner zone and the gas flow in the reforming zone adjacent to the heat exchange boundary are countercurrent.

6. A steam reformer of claim 1, wherein the flow of exhaust gas in the burner zone and the gas flow in the reforming zone adjacent to the heat exchange boundary are at an angle with respect to one another.

7. A steam reformer of claim 1, wherein the local rate of heat flux through the heat exchange boundary is controlled by varying the geometry of the heat flux control element.

8. A steam reformer of claim 1, wherein the burner zone comprises a downstream region and an upstream region; the upstream region having a higher rate of heat transfer from the burner zone to the heat exchange boundary than the downstream region.

9. A steam reformer of claim 1, wherein the burner zone comprises a downstream region and an upstream region, the portion of the heat flux control element occupying the upstream having a larger cross-sectional area than the portion of the heat flux control element occupying the downstream region.

10. A steam reformer of claim 1, wherein the heat flux control element comprises two or more zones.

11. A steam reformer of claim 10, wherein the zones are segregated by an insulating material.

12. A steam reformer of claim 10, wherein the zones are surface treated.

13. A steam reformer of claim 12, wherein the surface treatment of each zone is different.

14. A steam reformer of claim 13, wherein each zone has a different surface texture.

15. A steam reformer of claim 10, wherein each zone is of a different material.

16. A steam reformer of claim 10, wherein each zone has a different conductivity.

17. A steam reformer of claim 1, wherein the heat flux control element comprises a conductive core that is surrounded by a main structure.

18. A steam reformer of claim 17, wherein the conductive core is of a different material than the main structure.

19. A steam reformer of claim 1, wherein the heat flux control element comprises a multiplicity of individual inserts.

20. A steam reformer of claim 1, wherein the heat flux control element is a unitized structure.

21. A steam reformer of claim 20, wherein the heat flux control element conforms to the geometry of the heat exchange boundary.

22. A steam reformer of claim 1, wherein the heat flux control element is positionally aligned by at least one aligning element.

23. A steam reformer of claim 22, wherein the at least one aligning element is chosen from spokes and a shelf.
